(19) United States
(12) Patent Application Publication
(10) Pub. No.: US 2003/0163804 A1
(43) Pub. Date: Aug. 28, 2003

(54) Method for assuring compatibility and method for securing data within a distributed computer system

(76) Inventors: Wolfgang Burke, Munich (DE); Claus-Andreas Frank, Munich (DE); Dirk Hahnefeld, Starnberg (DE); Giovanni Laghi, Mering (DE); Johannes Schoepf, Furstenfeldbruck (DE); Bernhard Stryczek, Rosenheim (DE); Georg Zoeller, Steinebach (DE)

Correspondence Address: KEVIN R. SPIVAK, MORRISON & FOERSTER LLP, 1650 TYSON BLVD., SUITE 300, McLEAN, VA, 22102, US

(21) Appl. No.: 10/204,510

(22) PCT Filed: Feb. 13, 2001
(86) PCT No.: PCT/DE01/00546

(30) Foreign Application Priority Data
Feb. 23, 2000 (DE) 1008245.9

(51) Int. Cl. G06F 9/44

(52) U.S. Cl. 717/170

(57) ABSTRACT

The invention relates to a method for assuring compatibility between the software units activated in partial computer systems (system A, system B) belonging to a distributed computer system, said software units each comprising their respective version of software codes and/or data. Once a compatibility test has established compatibility, a compatible non-activated software unit is activated on its partial computer system and the corresponding previously activated software unit is deactivated. The invention also relates to a method for securing data within a distributed computer system with several partial computer systems, for blocking access to the data, for securing common data and for deactivating the data access block are carried out according to the current status of the data securing option.

The invention relates to a method for ensuring the compatibility between software units which are activated in computer subsystems which belong to a distributed computer system and each have one version standard of software code and/or data, and to a method for data back-up within a distributed computer system having a number of computer subsystems.

Distributed computer systems play a particular role in a preferred manner in present-day telecommunications systems, which are generally multiprocessor systems. A distributed computer system is characterized in particular in that processes can in each case be assigned to different processors, in which case the processors may possibly be located on physically separate platforms in the distributed computer system.

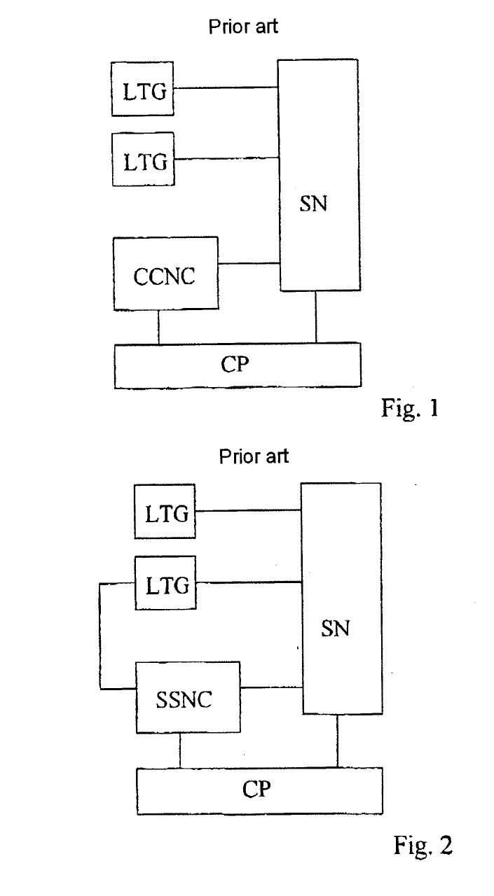

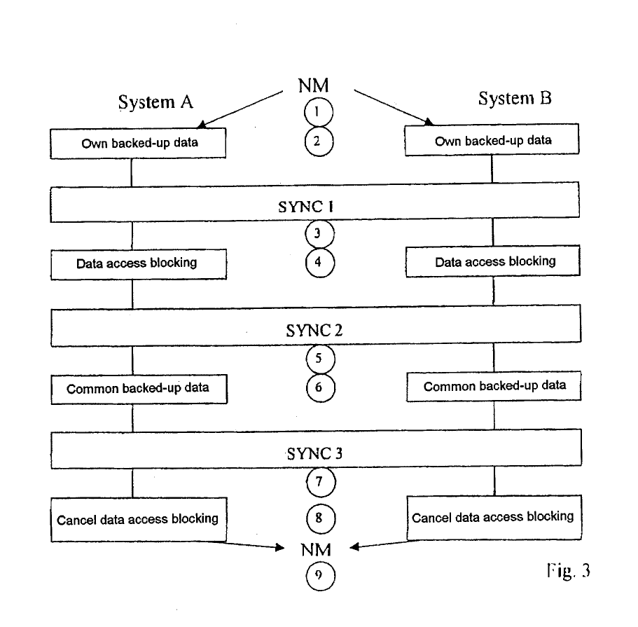

Distributed computer systems are being used increasingly in switching systems for telecommunications systems. Known traditional switching systems, such as the EWSD product (German abbreviation for electronic digital dialing system) from Siemens AG, whose architecture is illustrated by way of example in FIG. 1, have until now had only one main computer system, namely a coordination processor, which carries out and coordinates the control of the system components (for example the line trunk groups LTG, the switching network SN and the signaling control unit CCNC). A further development of the EWSD product provides, inter alia, for the signaling unit CCNC to be replaced by the signaling unit SSNC, which is illustrated in FIG. 2. FIG. 2 essentially shows the EWSD architecture which is illustrated on page 14 of a customer brochure from Siemens AG entitled “More Power for Higher Performance EWSD PowerNode”, issued in 1999, with the Order Number A50001-N2-P86-2-7600, Information and Communication Networks, Hofmannstr. 51, D-81359 Munich. In addition to an ATM based (Asynchronous Transfer Mode) platform, a further computer system, which is not illustrated explicitly in FIG. 2 but carries out a number of the tasks of the main computer system, is integrated in the system component SSNC. Operating software and application software for carrying out the tasks associated with the computer systems are in each case activated both on the main computer system CP and on the computer system for the SSNC, which is referred to as SSNC computer system in the following text. The software units which are activated in the main computer system and which generally each have a number of software modules are in this case loosely coupled to the software units which are activated in the SSNC computer system, that is to say: the software units of the two computer systems do not access a common memory, but require common data to carry out the application software. In order to ensure that the entire switching system operates correctly, it is necessary to ensure consistency between the common data on each computer subsystem (main computer system and SSNC computer system). The software units which are activated in the computer subsystems and each comprise a version standard of software code and data must also be mutually compatible.

To achieve this, it is necessary for a data back-up to be carried out, covering all the computer subsystems. A data back-up such as this should be initiated in particular after a software change, for example caused by an extensive so-called software update. This means that this data back-up is available for a renewed system initialization, for example a system new start or restart. During the system initialization, possible inconsistencies and incompatibilities must then be found, in order to allow these to be overcome during the system initialization.

Since the development trends in telecommunications systems are moving away from a central main computer system toward distributed computer systems having a number of computer subsystems, such data back-ups and system initializations are becoming subject to increasingly more stringent requirements, which make a significant contribution to ensuring consistency and compatibility.

The object of the invention is to develop a method for ensuring data consistency and compatibility between software units which are activated in computer subsystems, which method satisfies the requirements placed on a distributed computer system.

This object is achieved by the features specified in the independent claims. Further refinements of the invention are characterized in the dependent claims.

One major aspect of the invention is that the following steps are carried out in order to ensure compatibility between software units, which are activated in computer subsystems which belong to a distributed computer system, during system initialization of at least one such computer subsystem:

a) After finding an incompatibility between a software unit which is activated in a first computer subsystem and at least one software unit which is activated in a further computer subsystem, further software units which have not been activated and which exist on the respective computer subsystems are tested for compatibility,

b) In the event of compatibility being found from the test, a compatible software unit, which has not been activated, is activated in its computer subsystem, and the corresponding, previously activated, software unit is deactivated.

In this way, the method according to the invention satisfies the requirement for ensuring compatibility that is placed on a distributed computer system. In addition to this, this procedure results in the advantage that, when a computer subsystem refers back to a software unit with a relatively old update version standard, that is to say a “relatively old” software unit must be activated and/or loaded, the other computer subsystem likewise automatically refers back to a compatible software unit.

The method according to the invention is preferably used in a switching system which has at least two computer systems.

Said system initialization can be carried out in particular on a system new start or during restarting of the system.

In order to make the compatibility comparison easier, according to a further embodiment of the invention, version numbers of the software units which exist in a computer subsystem are entered in a list. In this case, the version number of a software unit which is activated in the computer subsystem is stored in first place in the list. A list such as this is preferably maintained in each such computer subsystem. The individual lists are thus searched for compatible software units. This leads to the appropriate compatible software units being activated on the respective computer subsystems.

The lists are expediently configured in such a way that each list element has one or more attributes. Thus, according to one development of the invention, the version number of a software unit is stored by setting a version attribute in the list.

It is worthwhile organizing the list elements in a list in such a way that the version numbers of the software units which are stored from the second place in the list are sorted in an ascending sequence on the basis of the time since they were last updated. This optimizes the time required to search for compatible software units.

A further advantageous refinement of the invention provides that, when an unactivated software unit which is compatible with a first computer subsystem has been found in a second computer subsystem, or vice versa, that software unit which has the latest version standard of the compatible unactivated software units in the second computer subsystem is always selected for activation of the compatible unactivated software unit. This ensures that the system is always provided with as many service features as possible in the applications, which are not normally available from software units with a relatively old update version standard.

The process of ensuring compatibility between software units which are activated on computer subsystems is expediently carried out automatically during system initialization of at least one such computer subsystem. Manual external initialization, if required, can but should not be necessary for this purpose.

A further major aspect of the invention is that a data back-up which is synchronized in the respective computer subsystems of the distributed computer system is initiated within a distributed computer system after a software change, with the following steps being carried out as a function of the current status of the data back-up procedure:

a) data back-up of data which other computer subsystems cannot access is carried out in each computer subsystem,

b) data access blocking is activated in each computer subsystem,

c) data back-up of data which other computer subsystems can also access is carried out in each computer subsystem, and

d) the previously activated data access blocks are deactivated again.

This ensures that the same data is backed up in each computer subsystem. The activated data access blocks result in requests to change the data to be backed up being rejected during the phase in which step c), as described above, is being carried out. This avoids inconsistencies in the data throughout the entire system. A further advantage of this method according to the invention is also that it creates, inter alia, an ideal precondition for guaranteed data consistency for the method according to the invention, as described above, for ensuring compatibility.

The data back-up process is preferably synchronized as follows: the computer subsystems are informed at said synchronization points that the data back-up which has in each case been initiated in a computer subsystem has reached a status which is defined for continuing the data back-up.

A data back-up method such as this is used in particular in a switching system having at least two computer systems.

One variant for defining the synchronization points in the data back-up procedure is to define time intervals, for example by means of a timer, at which the computer subsystems must be informed.

A further variant of the method according to the invention provides for the synchronization points to be implemented in the form of points defined in the software code.

One development of the invention provides for the version standard of the backed-up data to be stored in the respective computer subsystem after the data-back-up process. This makes it easier to check the data consistency for subsequent computation operations using the data. Ideally, this creates the capability to use the stored version standard for compatibility checking in accordance with the method according to the invention, as described above, for ensuring compatibility.

According to a further embodiment, the version standard of the backed-up data is stored by setting a version attribute which is stored in the respective computer subsystem.

A further refinement of the invention has been found to be particularly advantageous, in which the data back-ups which take place in the respective computer subsystems are controlled from a central point by means of control software. This makes it possible to initiate the data back-up method from a control system which is connected to the distributed computer system, and to monitor and control it while it is taking place.

In order to allow requests to change the data to be coped with during the data back-up process and, if appropriate, to be applied to the appropriate data after completion of the data back-up, information relating to rejected changes to the data to be backed up is, according to one development of the invention, stored temporarily in a record file during the data access block. Once the data access block has been canceled, the data back-up is generally complete

An exemplary embodiment of the invention will be described in more detail in the following text with reference to a drawing, in which:

FIG. 1 shows the example of the architecture, as mentioned above, of a traditional switching system,

FIG. 2 shows an example of the architecture, as mentioned above, of a further development of the traditional switching system,

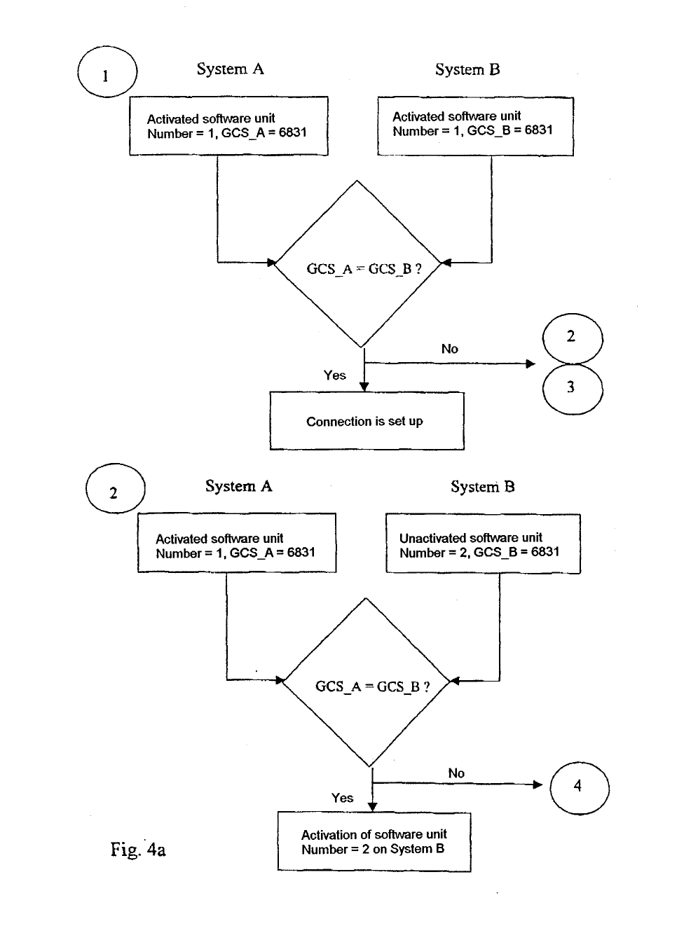

FIG. 3 shows an example of the procedure for the data back-up method according to the invention,

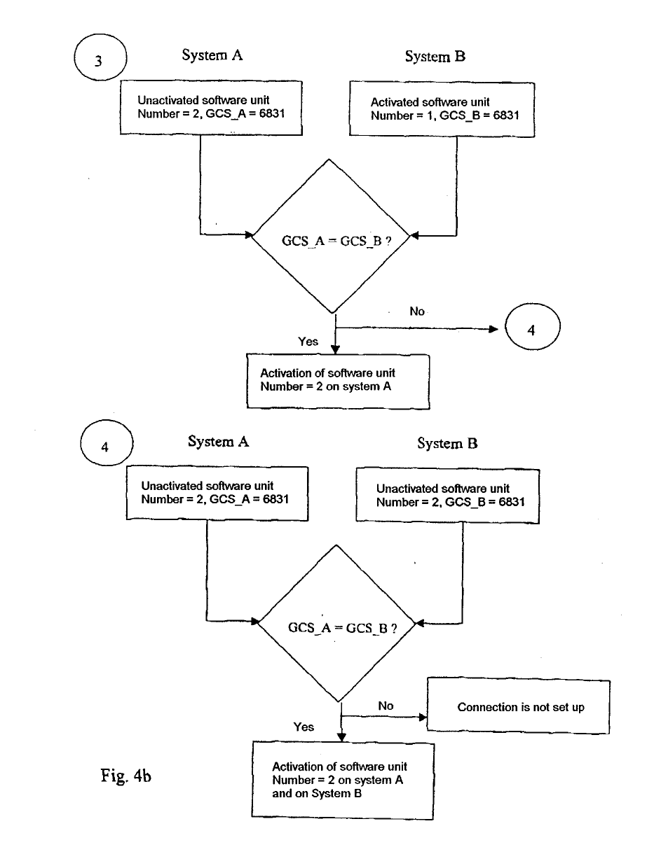

FIGS. 4a and 4b show an example of a flowchart for compatibility comparison in the method according to the invention.

FIG. 3 shows a computer subsystem System A, for example the main computer system, and a further computer subsystem System B, for example the SSNC computer system. Further, method steps are identified by numbers surrounded by circles in the figure. The previously mentioned synchronization points, which are defined in the data back-up procedure, are annotated SYNC 1 to SYNC 3 in the figure.

In particular after a software change or update, a data back-up on the computer subsystem System A and on the computer subsystem System B is in each case initiated in step 1 by means of so-called network manager software NM, which is installed in a control system which is connected to the entire system. Each computer subsystem protects its own data in step 2 until each computer subsystem has reached a synchronization point in the data back-up run. In this case, the computer subsystem System A cannot access the data to be backed up for the computer subsystem System B, and the computer subsystem System B cannot access the data to be backed up for the computer subsystem System A.

In step 3, the computer subsystems System A and System B are informed that they have both reached the synchronization point SYNC 1. Data access blocks are applied to both computer subsystems in the next step 4. From this time, no changes can be made to the data that is subsequently to be backed up. Once both computer subsystems have reached the synchronization point SYNC 2 in step 5, common data in each computer subsystem is backed up in step 6.

This common data is distinguished by the fact that it is available to both computer subsystems. For data such as this that is to be backed up, it is particularly advantageous for its version standard to be stored in each of the computer subsystems. This is normally done by setting a version attribute, which is stored in each of the computer subsystems and is usefully used in particular in the method as explained with reference to FIGS. 4a and 4b.

Requests to change the common data that is now to be backed up are rejected. Information about rejected changes may be stored temporarily in a record file. Once both computer subsystems have reached the synchronization point SYNC 3 in step 7, the data access blocks on each subsystem are canceled once again in step 8. Once the data access block has been canceled, changes can once again be made to the data. In particular, previously rejected change requests can be applied to the data on the basis of the information stored in the record file.

Once the data back-up has been carried out successfully, a positive signal is sent, in step 9, to the network manager software NM in the control system.

The synchronization points SYNC 1 to SYNC 3 which have been mentioned may be implemented in various variants Firstly, a timer in each computer subsystem can define a time at which a message about the status reached in the data back-up procedure is sent to the other computer subsystem. Secondly, the synchronization points can be implemented in the software code, for example in such a way that a message is sent to the other computer subsystem at specific points in the software code.

Examples of the lists which are used for ensuring compatibility for the method according to the invention are shown in the following text, in which lists the version standards of the software units in the computer subsystems (for example the main computer system CP and the SSNC computer system) are stored:

List for the CP:
‘--------------------------- ’
‘--EWSD (CP) Generation list-- ’
‘--------------------------- ’
EWSD_JOB_REG.EWSD_GENLIST

| | | | | |
|---|---|---|---|---|
| (1) | | | | |
| | .GEN (1. .8) = ‘23680101’ | \| | activated | software |
| | .GCS=4567 | | unit | |
| | .STATE=ROGC_VALID | | | |
| (2) | | | | |
| | .GEN (1. .8) = ‘23680105’ | | | |
| | .GCS=6831 | \| | version | attribute |
| | .STATE=ROGC_VALID | | (GCS: | Generation |

| | | |
|---|---|---|
| (3) | | Compatibility Sign) |
| | .GEN (1. .8) = ‘ ’ | |
| | .GCS=9999 | |
| | .STATE=ROGC_EMPTY | |

(4. .31) EQUAL ABOVE ELEMENT

List for the SSNC:
‘--------------------------- ’
‘--SSNC GENERATION LIST--’
‘---------------------------’
C00MTC5A.KCGCPD0A.CGCHKD0S.SVH331P_HANDLE_SWM_{—}
PRG_RPT.SWM_PRG_RPT_INFO.GEN_LIST

| | | | | |
|---|---|---|---|---|
| (1) | | | | |
| | .GEN_NAME (1. .8) = | | | |
| | ‘DBPXEO0V’ | | | |
| | .GCS=6831 | \| | activated | software |
| | .BAP=0 | | unit | |
| | .STATE=KSFM604_VALID | | | |
| (2) | | | | |
| | .GEN_NAME (1. .8) = | | | |
| | ‘BACKUP01’ | | | |
| | .GCS=1234 | \| | unactivated | software |
| | .BAP=1 | | unit | |
| | .STATE=KSFM604_VALID | | | |
| (3) | | | | |
| | .GEN_NAME (1. .8) = ‘ ’ | | | |
| | .GCS=9999 | | | |
| | .BAP=5 | | | |
| | .STATE-KSFM604_EMPTY | | | |
| (4) | | | | |
| | .GEN_NAME (1. .8) = ‘ ’ | | | |
| | .GCS=9999 | | | |
| | .BAP=5 | | | |
| | .STATE=KSFM604_{—} | | | |
| | UNDEFINED | | | |
| (5) | EQUAL ABOVE ELEMENT | | | |

Example of a reaction to the compatibility check, in which the two above lists are compared with one another:

| | | |
|---|---|---|
| ‘----------------------------’ | | |
| ‘--! ! ! ! ! ! ! ! ! ! ! ! ! ! ! ! ! ! ! ! ! ! ! !--’ | | |
| ‘--GENERATION CHECK DECISION--’ | | |
| ‘--! ! ! ! ! ! ! ! ! ! ! ! ! ! ! ! ! ! ! ! ! ! ! ! ! !--’ | \| | Referral back |
| EWSD_JOB_REG.DECISION= | | to “relatively |
| ROGC_EWSD_FALLB_REQ | | old” software |
| EWSD_JOB_REG.COMMON_GCS=6831 | | unit in the CP |
| EWSD_JOB_REG.EWSD_{—} | | |
| FB_TO_NEXT_GEN=FALSE | | |
| EWSD_JOB_REG.COLDST_SYNC=FALSE | | |

In the example of a list as shown above, a version attribute GCS (Generation Compatibility Sign) is used to identify the version standard of a software unit, and is used as the basis for carrying out the compatibility check, for example in accordance with FIGS. 4a and 4b as explained in the following text.

FIGS. 4a and 4b show the compatibility check, which is carried out in the method according to the invention, between software units that exist in the computer subsystems System A and System B, as well as the reaction to the compatibility check. The numbers which are identified by circles mark entry points into the compatibility check, which result from searching through said lists for compatible software units. This method is carried out in particular during system initialization, for example after a software update or change.

The following investigation is carried out at the entry point 1: the version number of the version attribute GCS_A of the software unit which is activated in the computer subsystem System A and has the number 1 matches the version number, for example 6831, of the version attribute GCS_B of the software unit which is activated in the computer subsystem System B and has the number 1. This results in a connection being set up between the computer subsystem System A and the computer subsystem System B during the system initialization of the entire system. In the situation where the version attributes GCS_A and GCS_B do not match, said lists are investigated further for compatible software units, in which case the entry point 2 or the entry point 3 may be used for the compatibility check.

The version attribute GCS_of the software unit which is activated on the computer subsystem System A and has the number 1, and the version attribute GCS_B of a software unit which is not activated on the computer subsystem System B and has the number 2, are compared with one another at the entry point 2. The software unit with the latest update version standard by the possible compatible unactivated software units is preferably used in the computer subsystem System B. In the situation where the version attributes GCS_A and GCS_B match, the computer subsystem System B refers back to the software unit with the number 2. Referring back means, the currently activated software unit in the computer subsystem System B is deactivated and, instead of this, the previously unactivated software unit with the number 2 is activated in this system. If the version attributes GCS_A and GCS_B do not match, the process of searching through said lists further leads to the entry point 4.

The compatibility check at the entry point 3 is analogous to that at the entry point 2. The comparison of the version attributes GCS_A and GCS_B results, however, in the event of a match to referral back to the “relatively old” unactivated software unit with the number 2 in the computer subsystem System A. If the version attributes do not match, it is possible to go to the entry point 4.

Two version attributes GCS_A and GCS_B of two software units which are not activated on the respective computer subsystem System A or System B are compared with one another at the entry point 4. If the two version attributes match, the unactivated software units in the computer subsystem System A and in the computer subsystem System B are activated, and the previously activated software units are deactivated. If the two version attributes do not match, an error message is produced and no connection is set up between the two computer subsystems System A and System B during the system initialization.

The exemplary embodiment of the method according to the invention may, of course, be applied analogously to distributed computer systems with a number of computer subsystems. To do this, each computer subsystem has a list which contains all the software units for a computer subsystem. All the existing lists are thus searched through for compatible software units, using the version attribute. All the version attributes are compared with one another. Appropriate reactions in the computer subsystems are initiated on the basis of the comparison result.

1. A method for ensuring the compatibility between software units which are activated in computer subsystems (System A, System B) which belong to a distributed computer system and each have one version standard of software code and data, during system initialization of at least one such computer subsystem, with the following steps being carried out:
a) after finding an incompatibility between a software unit which is activated in a first computer subsystem and at least one software unit which is activated in a further computer subsystem, further software units which have not been activated and which exist on the respective computer subsystems are compared-with one another for compatibility,
b) in the event of compatibility being found from the comparison, a compatible software unit, which has not been activated, is activated in its computer subsystem, and the corresponding, previously activated, software unit is deactivated.

2. The method as claimed in claim 1, characterized in that the system initialization is carried out on a system new start, and/or when restarting the system.

3. The method as claimed in claim 1 or 2, characterized in that version numbers of the software units which exist in a computer subsystem are entered in a list, with the version number of an activated software unit being stored in first place in the list.

4. The method as claimed in claim 3, characterized in that the version number of a software unit is entered in the list by setting a version attribute (GCS).

5. The method as claimed in one of the preceding claims, characterized in that the version numbers of software units which are entered from the second place in the list are sorted in an ascending sequence on the basis of the time since they were last updated.

6. The method as claimed in one of the preceding claims, characterized in that that software unit which has the latest version standard of the compatible software units which have not been activated is always selected for activation of a compatible unactivated software unit.

7. The method as claimed in one of the preceding claims, characterized in that compatibility between software units which are activated in computer subsystems is ensured automatically during the system initialization of at least one such computer subsystem.

8. A method for data back-up within a distributed computer system having a number of computer subsystems (System A, System B) within which a data back-up is initiated in each computer subsystem after a software change, and is synchronized in the respective computer subsystems at synchronization points which are defined in the data back-up procedure, with the following steps being carried out as a function of the current state of the data back-up procedure:
a) a data back-up of data which other computer subsystems cannot access is carried out in each computer subsystem,
b) a data access block is activated in each computer subsystem,
c) a data back-up of data which other computer subsystems can also access is carried out in each computer subsystem, and
d) the data access blocks are deactivated.

9. The method as claimed in claim 8, characterized in that, for synchronization of the data back-up, the computer subsystems are informed at the synchronization points that the data back-up which has in each case been initiated in a computer subsystem has reached a status which is defined for continuing the data back-up.

10. The method as claimed in claim 8 or 9, characterized in that the synchronization points are defined by time intervals.

11. The method as claimed in claim 8 or 9, characterized in that the synchronization points are implemented in the form of points defined in the software code.

12. The method as claimed in one of claims 8 to 11, characterized in that, after the data back-up, the version standard of the backed-up data is stored in the respective computer subsystem.

13. The method as claimed in one of claims 8 to 12, characterized in that the version standard of the backed-up data is stored by setting a version attribute (GCS), which is stored in the respective computer subsystem.

14. The method as claimed in one of claims 8 to 13, characterized in that the data back-ups which take place in the respective computer subsystems are controlled from a central point by means of control software.

15. The method as claimed in one of claims 8 to 14, characterized in that information relating to rejected changes to the data to be backed up is held temporarily in a record file during the data access block, in order to allow the changes to the data to be carried out once the data access block has been canceled.

16. The method as claimed in one of the preceding claims, characterized in that said method is used in a switching system which has at least two computer systems (CP, SSNC).
